(19) United States
(12) Patent Application Publication
(10) Pub. No.: US 2007/0288316 A1
(43) Pub. Date: Dec. 13, 2007

(54) Method of and system for sporting event spectator interaction

(76) Inventors: Lionel R. Burns, Alto, NM (US); Joe Gregory, Grapevios, TX (US)

Correspondence Address: WINSTEAD PC, P.O. BOX 50784, DALLAS, TX, 75201, US

(21) Appl. No.: 11/800,668

(22) Filed: May 7, 2007

Related U.S. Application Data
(60) Provisional application No. 60/798,983, filed on May 9, 2006.

(51) Int. Cl. G07G 1/14

(52) U.S. Cl. 705/14; 283/102

(57) ABSTRACT

A method for providing spectator interaction in a sporting event of a type including a plurality of participants, each of the plurality of participants having been assigned an indicia for identification and spectator interaction. The method includes providing a hidden indicia on each one of a plurality of tickets, the hidden indicia associated with the indicia assigned to each of the plurality of participants of the sporting event. The plurality of tickets having the hidden indicia are then distributed. A spectator acquires at least one ticket from the plurality of tickets and reveals the hidden indicia. Spectator interaction is facilitated when the spectator compares the hidden indicia on the at least one ticket with the indicia assigned to a winning participant of the sporting event. The at least one ticket is then redeemed for reward if the hidden indicia on the at least one ticket matches the indicia assigned to the winning participant.

### CROSS-REFERENCE TO RELATED APPLICATIONS

This patent application claims priority from, and incorporates by reference the entire disclosure of, U.S. Provisional Patent Application No. 60/798,983, filed May 9, 2006.

### BACKGROUND OF THE INVENTION

1. Field of the Invention

The present invention relates to a method of and system for providing spectator interaction in a sporting event and, more particularly, but not by way of limitation, to the distribution and/or sale of tickets having removably hidden indicia associated with particular participants of a sporting event relative to which the tickets are distributed/or sold for allowing redemption of the tickets for acknowledgment and/or winnings if the revealed indicia (such as, for example, a “number”) matches the winning participants' indicia.

2. History of Related Art

Spectator involvement in contests and/or sporting events has existed for centuries, if not for many millennia. The activities of participants in the sporting event often include indicia allowing the spectators to know which participant is involved in which event and/or is succeeding in that sporting event. The indicia in modem times is often “numerical”. Likewise, the placing of wagers on sporting events based upon the various talents and/or efforts of participants has been common. However, monetary reward is not always the reason for spectator support of various participants. That aside, “wagering” is in modem days a major business, and many bets are placed with the anticipation of financial reward, or “winnings”. Likewise, modern day spectators may not even attend the sporting event and thanks to technology, may even be in other countries.

Many methods and systems for placing wagers on sporting events currently exist. Such methods for placing wagers on a sporting event include receiving an order from a purchaser for a secondary wager ticket and a sum of money, tracking the sum of money in an account, and providing to the purchaser the secondary wager ticket having a random number and a probable winning number related to a wager on the sporting event. A portion of the account is paid for each presented winning secondary wager ticket after the sporting event is completed. The secondary wager ticket can be a scratch ticket or a pull tab ticket. The secondary wager ticket can be provided in association with the purchase of a traditional wager ticket.

Other prior methods include, for example, a racing format playing area having four lanes labeled with four different symbols. The lanes are partitioned into a number of stations which correspond to a unit of length (such as a furlong for horse races). Players place a wager on a lane which they believe will win the race. Playing pieces are sequentially dealt from a set of playing pieces which contain equal number of each symbol. Each time a symbol is dealt, a marker for the corresponding lane is moved forward one station until one marker reaches a finish position. Players who have placed a wager on the winning lane win a payoff. Then, additional playing pieces are dealt on playing piece receiving stations. The player wins a bonus payoff depending upon how many of these additional playing pieces match the symbol of the winning lane.

It would be an advantage therefore to provide a spectator interaction inducement method and system relative to the participants of a sporting event for increasing spectator interaction in the sporting event in a manner that facilitates enjoyment of the sporting event whether or not a “bet” is placed. The present invention provides such a method and system as further described below.

### SUMMARY OF THE INVENTION

The present invention relates to a method of and system for sporting event spectator interaction. More particularly, one aspect of the invention includes a method for providing spectator interaction in a sporting event of a type including a plurality of participants, each of the plurality of participants having been assigned an indicia for identification and spectator interaction. The method comprises, in one embodiment, providing a hidden indicia on each one of a plurality of tickets, the hidden indicia associated with the indicia assigned to each of the plurality of participants of the sporting event.

The plurality of tickets having the hidden indicia are then distributed. A spectator then acquires at least one ticket from the plurality of tickets and reveals the hidden indicia. Spectator interaction is facilitated when the spectator compares the hidden indicia on the at least one ticket with the indicia assigned to a winning participant of the sporting event. The at least one ticket is then redeemed for reward if the hidden indicia on the at least one ticket matches the indicia assigned to the winning participant.

In another aspect, one embodiment of the invention includes the above described method, wherein the step of distributing the plurality of tickets includes the step of selling the plurality of tickets.

In another aspect, one embodiment of the invention includes the above described method, wherein the step of distributing the plurality of tickets includes the step of delivering the plurality of tickets to the spectators in association with a charitable event.

In another aspect, one embodiment of the invention includes the above described method, wherein the sporting event comprises an event from the group of baseball games, football games, basketball games, automobile races, track meets, marathons, equestrian competitions, rodeo competitions, and charitable competitions.

In another aspect, one embodiment of the invention includes the above described method, wherein the indicia comprises letters from an alphabet.

In another aspect, one embodiment of the invention includes the above described method, wherein the indicia includes a numeric value.

In another aspect, one embodiment of the invention includes the above described method, wherein the step of acquiring the at least one ticket tickets includes the step of purchasing the at least one ticket.

In another aspect, one embodiment of the invention includes the above described method, wherein the step of redeeming the at least one ticket for reward includes the step of redeeming the at least one ticket for acknowledgment.

In another aspect, one embodiment of the invention includes the above described method, wherein the step of redeeming the at least one ticket for reward includes the step of redeeming the at least one ticket for money.

In another aspect, one embodiment of the invention includes the above described method, wherein the step of redeeming the at least one ticket for reward includes the step of redeeming the at least one ticket for personal satisfaction.

In another aspect, one embodiment of the invention includes the above described method, wherein the step of redeeming the at least one ticket for reward includes the step of redeeming the at least one ticket for a gift.

In another aspect, one embodiment of the invention includes the above described method, wherein the hidden indicia is covered with a scratch-off layer.

In another aspect, one embodiment of the invention includes the above described method, wherein the hidden indicia is covered with a break-open window.

In another aspect, one embodiment of the invention includes the above described method, wherein the at least one ticket is acquired from a ticket vendor.

In another aspect, one embodiment of the invention includes the above described method, wherein the at least one ticket is acquired via an electronic booth.

In another aspect, one embodiment of the invention includes the above described method wherein the at least one ticket is acquired via a global interconnection network.

In another aspect, one embodiment of the invention includes a method for providing spectator interaction in a sporting event of a type including a plurality of participants, each of the plurality of participants having been assigned an indicia for identification and spectator interaction. The method comprises forwarding a numeric value to at least one spectator, the numeric value associated with the indicia assigned to each of the plurality of participants of the sporting event. Next, the numeric value is compared with the indicia assigned to a winning participant of the sporting event and a financial reward is redeemed if the numeric value matches the indicia assigned to the winning participant.

In another aspect, one embodiment of the invention includes the above described method, wherein the step of forwarding is performed by a computer.

In another aspect, one embodiment of the invention includes the above described method, wherein the step of forwarding is performed by a telephone.

In another aspect, one embodiment of the invention includes the above described method, wherein the step of forwarding is performed via facsimile.

In another aspect, one embodiment of the invention includes the above described method, wherein the sporting event comprises an event from the group of baseball games, football games, basketball games, automobile races, track meets, marathons, equestrian competitions, rodeo competitions, and charitable competitions.

In another aspect, one embodiment of the invention includes the above described method, wherein the indicia includes a numeric value.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates a front view of a ticket produced in accordance with an embodiment of the present invention;

FIG. 2 illustrates a front view of a ticket produced in accordance with an alternate embodiment of the present invention;

FIG. 3 illustrates a flow diagram in accordance with an embodiment of the present invention; and

FIG. 4 illustrates diagrammatic schematic of an alternate embodiment of the present invention.

### DETAILED DESCRIPTION OF ILLUSTRATIVE EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

It has been found that spectator interaction in a sporting event of the type including multiple participants, each of which are assigned a given number for purposes of identification and spectator association can be enhanced by the spectators receiving tickets which include numbers associated with participants of the sporting event. The ability of the spectator to associate with a given participant whether by wagering or otherwise, has been found to enhance spectator interaction. Since spectator interaction is a dominant, driving force in sporting events, this enhancement of spectator interaction is an important development. The term spectator as used herein, is not limited to individuals physically present at the event and include, but is not limited to, individuals and entities distant from the event and manifesting any form of interest therein.

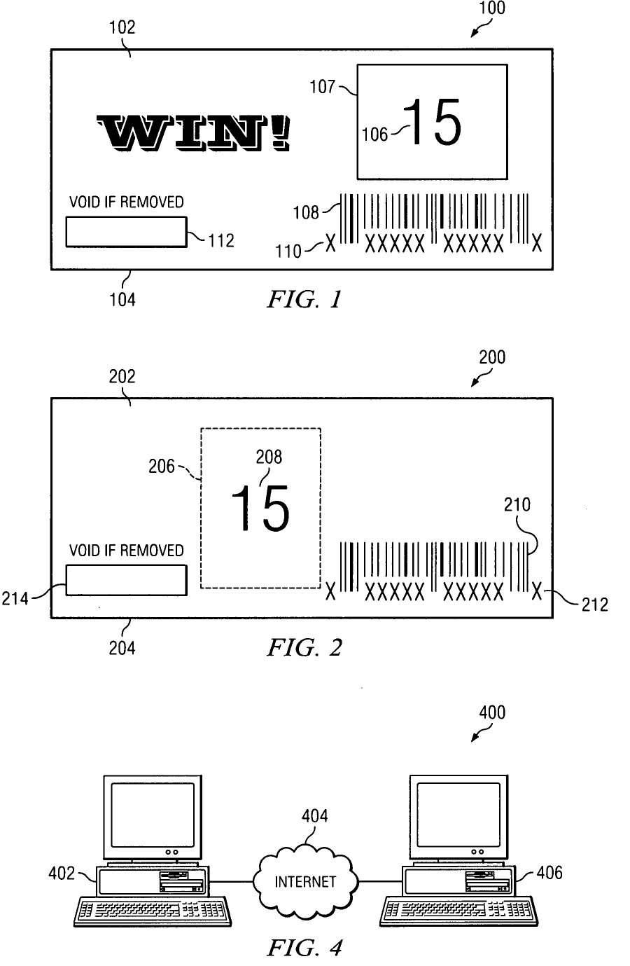

Referring first to FIG. 1, there is shown one embodiment of a ticket 100 constructed in accordance with principles of the present invention. The ticket 100 is formed of, for example, a substantially flat substrate sheet material. The ticket 100 has a front surface 102 and a rear surface 104. The front surface 102 has indicia 106 printed thereon. The indicia 106 represents a sporting event participant. The indicia 106 is covered with a scratch-off layer 107 as shown in FIG. 1. The indicia 106 is obscured with a scratch-off layer 107 which is removed by a ticket holder when playing to reveal the indicia 106. The ticket holder may be, for example, a spectator attending a sporting event. The ticket 100 further includes a bar code 108 printed on the front surface 102 of the ticket 100 for identifying and redeeming the ticket 100. A human readable portion of the bar code 108 is indicated at 110. In addition, a void if removed section for security, that may be a machine and/or human readable code covered by a scratch-off layer marked “void if removed” is indicated at 112.

Still referring to FIG. 1, the scratch-off layer 107 is constructed to reveal the indicia 106 printed on the ticket 100 and obscured by the scratch-off layer 107. The indicia 106 may be, for example, a numerical value corresponding to a number assigned to the sporting event participants. For example, according to an embodiment of the present invention, in a twenty participant car racing event, every participant has a distinct numerical value assigned to their car. The indicia 106 representing the numerical value on the ticket 100 corresponds to the numerical value assigned to the cars participating in the racing event. This allows the spectators to associate with a given participant whether by wagering or otherwise, to enhance spectator interaction. According to an embodiment of the present invention, the sporting event may be one of a variety of events such as, for example, football games, basketball games, baseball games, car racing such as, for example, NASCAR events. With the latter, the winner of a NASCAR event is typically identified by a number and therefore numerical indicia would be the most obvious form of participant identification. However, the indicia can be a letter, indicia can be a number, and indicia may be the name and/or other identifying nomenclature relative to a participant and/or participant's team. In team events, both the team as well as the participant could be the subject of such a method and system in accordance with the principles of the present invention and then the “most valuable player (“MVP”) is determined at a given sporting event and/or high scorer individuals.

In use, a spectator acquires a ticket 100. The spectator removes the scratch-off layer 107 on the ticket 100 to reveal the indicia 106 at any time after acquiring the tickets 100. After a sporting event is completed, the spectator reviews the information on the ticket 100 to determine if the indicia 106 on the ticket 100 matches the numerical value associated with the winner of the sporting event. If the spectator is a winner, the ticket 100 is presented to, for example, a clerk at a ticket booth for redemption. According to an alternate embodiment, the spectator may be a winner if the indicia 106 on the ticket 100 matches the numerical value associated with a runners-up of the sporting event. In yet another alternate embodiment, the spectator may be a winner if the indicia 106 on the ticket 100 matches the numerical value associated with top 10 finishers of the sporting event. This determination is made by the sporting event organization. Preferably, the ticket 100 is presented to the clerk at the ticket booth before the end of business on the same date of the sporting event. But other “presentees” of the ticket are contemplated, such as that provided by the World Wide Web and “interaction” between/among web users.

Referring first to FIG. 2, there is shown an alternate embodiment of a ticket 200 constructed in accordance with the principles of the present invention. The ticket 200 is formed of, for example, a substantially flat substrate sheet material. The ticket 200 has a front surface 202 and a rear surface 204. The front surface 202 has indicia 208 printed thereon. The indicia 208 represents a sporting event participant. The indicia 208 is covered with a break-open window 206 as shown in FIG. 2. The indicia 208 is obscured with the break-open window 206 which is removed by a ticket holder when playing to reveal the indicia 208. The ticket holder may be, for example, a spectator attending a sporting event. The ticket 200 further includes a bar code 210 printed on the front surface 202 of the ticket 200 for identifying and redeeming the ticket 200. A human readable portion of the bar code is indicated at 212. In addition, a void if removed section for security, that may be a machine and/or human readable code covered by a scratch-off layer marked “void if removed” is indicated at 214.

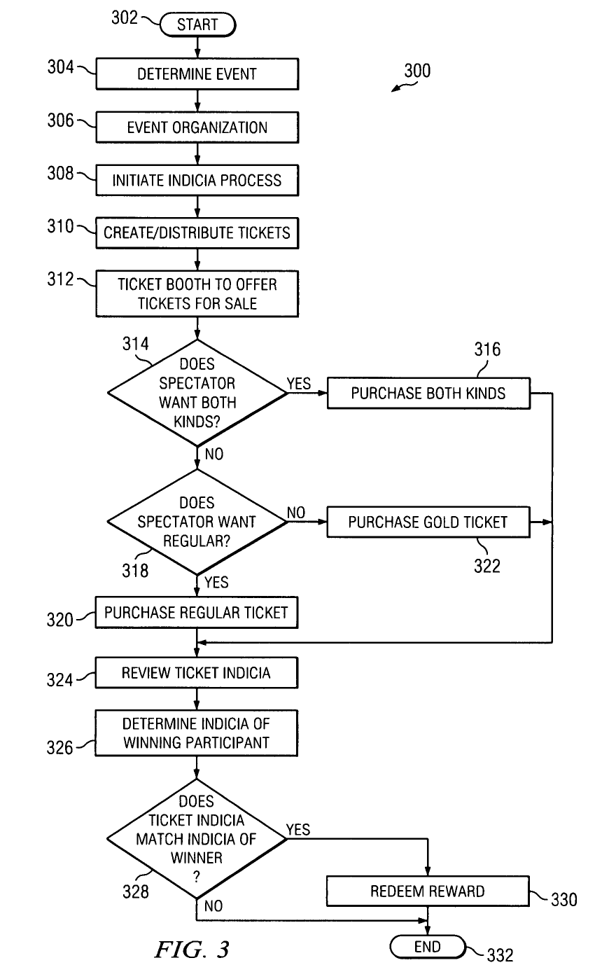

Referring now to FIG. 3, there is shown a flow diagram of a process 300 in accordance with an embodiment of the present invention. The process 300 starts at step 302. At step 304, a determination is made as to which sporting event is appropriate for use with the method and system for sporting event spectator interaction in accordance with the principles of the present invention. Once such a sporting event is determined, the sporting event organization is reviewed at step 306. Step 306 comprises an analysis of the possibility of involvement in the sporting event and/or authority from the sporting event organization for utilization of the systems and methods of the present invention. If the sporting event organization authorization is both required and affirmative, spectator interaction initiatives are established which are directly related to the determination of the event. At step 306, a further determination is made of the number of participants in the sporting event. At step 308, an indicia determination process is initiated. The indicia determination process requires for a determination of the total number of participants in the sporting event and assigning a numerical value to the tickets 100. For example, in a twenty participant car racing event, every participant has a distinct numerical value assigned to their car. The indicia 106 representing the numerical value on the ticket 100 corresponds to the numerical value assigned to the cars participating in the racing event. This allows the spectators to associate with a given participant whether by wagering or otherwise, to enhance spectator interaction.

The process 300 continues to step 310. At step 310, the tickets 100 are generated with an indicia 106. The indicia 106 may be, for example, a numerical value corresponding to a number assigned to the sporting event participants. The indicia 106 is obscured with a scratch-off layer 107 which is removed by a ticket holder when playing to reveal the indicia 106. Step 310 further includes the creation of a distribution network for the tickets 100 for utilization at the sporting event pursuant to authorization from the sporting event organization. According to an embodiment, the step of “distributing” the tickets and/or information to the spectators may include selling, donating, giving away, or otherwise distributing such information. In that regard, a ticket distributor or vendor is thus supplied with the tickets 100 (step 312) so that the spectators can acquire (and in some cases purchase) one or more tickets 100 from the vendor, in accordance with one embodiment of the present invention.

In an alternate embodiment, the tickets 100 may be acquired (and in some cases purchased) via electronic ticket dispensing booths. As referenced above, the “purchase” of tickets may not always be preferable. In a charitable event associated with a sporting event, a donation and/or a giveaway of such tickets may be preferable because the present invention is not limited to financial remuneration relative to the scratch-off tickets. In accordance with the principles of the present invention, spectator interaction is the ultimate goal, which spectator interaction may be afforded by simple recognition of having the correct ticket, some other form of non-financial reward such as a photograph of a participant in the sporting event and/or actual financial remuneration. All are considered possibilities in accordance with the spirit and scope of the present invention.

From step 312, the process proceeds to step 314. At step 314, in acquiring one or more tickets either by purchase or giveaway, it is determined if the spectator prefers to acquire the various kinds of tickets 100 offered. For example, the tickets may be a “Regular ticket” or a “Gold ticket”. The difference between a regular ticket and a gold ticket is simply a reference to a possibility that different levels of spectator interaction and/or different reward systems may be utilized in accordance with the principles of the present invention and the ultimate sporting event thus determines which ticket is the ticket of the winning participant so that either recognition, reward, and/or financial winnings may be provided in accordance with the principles of the present invention. If it is determined at step 314 that the spectator desires to acquire both the regular and gold tickets, the process proceeds to step 316. At step 316, the spectator acquires both the regular and gold tickets and the process proceeds to step 324.

However, if it is determined at step 314 that the spectator does not desire to acquire both the regular and gold tickets, the process proceeds to step 318. At step 318, it is determined if a spectator desires to acquire regular tickets. If it is determined at step 318 that the spectator desires to acquire only the regular tickets, the process proceeds to step 320. At step 320, the spectator acquires at least one regular ticket and the process proceeds to step 324. However, if it is determined at step 318 that the spectator does not desire to acquire regular tickets, the process proceeds to step 322. At step 322, the spectator acquires at least one gold ticket and the process proceeds to step 324. At step 324, the spectator reviews the ticket indicia 106. According to an exemplary embodiment, the indicia 106 is covered with a scratch-off layer 107 as shown in FIG. 1. The indicia 106 is obscured with a scratch-off layer 107 which is removed by the spectator when playing to reveal the indicia 106. According to an alternate embodiment, the indicia 208 is covered with a break-open window 206 as shown in FIG. 2. The indicia 208 is obscured with the break-open window 206 which is removed by the spectator when playing to reveal the indicia 208. After reviewing the indicia at step 324, the process proceeds to step 326.

At step 326, the spectator determines the indicia of the winning participant. The indicia of the winning participant may be, for example, a number assigned to the winner of the sporting event. The process 300 proceeds to step 328. At step 328, it is determined if the indicia on the ticket matches the indicia of the winner of the sporting event. If it is determined that the indicia on the ticket does not match the indicia of the winner of the sporting event, the process 300 ends at step 332. However, if it is determined at step 328 that the indicia on the ticket matches the indicia of the winner of the sporting event, the process 300 proceeds to step 330. At step 330, the spectator redeems the reward associated with the ticket and the process 300 ends at step 332.

Referring now to FIG. 4, there is shown a diagrammatic schematic 400 of another aspect of the present invention wherein tickets are replaced with another form of “to be revealed” sporting event participant notification. For example, a random generation of participants may be created in a first computer 402 and distributed to a select group (computer 404) through a global interconnection network 404 by subscription and/or voluntary association at no cost. The global interconnection network 404 may be, for example, the Internet. In such a scenario, the names an/or numerical identification of the sporting event participant is not known to the spectator prior to receipt of the information via, for example, email. According to alternate embodiment, communication means may be utilized such as, for example, telephone calls, faxes, mail, delivery and/or any other form of communication for the distribution of randomly distributed participant names and/or indicia associated with a given participant in a given sporting event are provided. In this manner, a large group of spectators may be actively involved and spectator interaction initiated through the ability to have a designated knowledge of a given sporting event participant relative to a given spectator.

In one embodiment of the invention, the spectator is not present at the sporting event but may view the sporting event by communication means, such as television. Therefore the actual “scratching off” of a “physical ticket” is not necessary in each embodiment of the present invention. Moreover, financial reward as a result of “gambling” is likewise not necessary in accordance with the spirit and scope of the present invention. It may be that with famous sporting event participants, a photographic opportunity to have one's photograph taken with a given participant and/or the receipt of a picture of the participant at such a sporting event would be sufficient reward for spectator interaction and an increase in interest in the sporting event. This latter aspect could be ideal for charitable and/or “not for profit” organizations and/or associations.

Finally, in operation, the method of the present invention provides spectator interaction in a specific sport event of the type including multiple participants, each of which having been given an indicia for identification and spectator association. This may be via, for example, mail or fax. The method of the present invention, in one embodiment as defined above, comprises providing tickets and/or other forms of communication relative to a specific sporting event such that the tickets and/or other form of communication have indicia associated with a particular participant of a sporting event. In the event of a physical ticket, the indicia is, in one embodiment preferably hidden and may only be seen once it is made viewable by scratching off of a surface covering said indicia or by similar methods. The tickets and/or other forms of communication are then distributed to the spectators, who may or may not be at the event who then acquire the tickets and/or other form of communication to therein have access to the identification of a particular sporting event participant. The spectators are then able to identify the sporting event participant by either revealing an indicia on a physical ticket and/or receiving the communication relative to a non-physical ticket as described above so as to understand which participant in the sporting event is represented thereby. Spectator interaction is therein facilitated by allowing the spectator to compare the indicia of the participant from a physical ticket or with the identity of the participant in a non-physical ticket with the winning participant's identification and/or indicia in the sporting event. In certain embodiments, the physical ticket and/or communication is then redeemed and/or returned for a reward with the indicia and/or identity of the sporting event participant matches the winning participant's number.

Still referring to the methods and operation of the present invention as described above, the acquisition of the ticket is, again as mentioned above, available by either purchase and/or donation. The term acquisition as used herein includes the actual purchase of the ticket or the obtaining of a ticket by an individual who was not required to purchase a ticket such as at a civic or charitable event. Likewise the term reward may simply be an acknowledgment of the spectator having the name of the winning participant but the possibly of having financial reward or money (as in the case of gambling) and/or simply personal satisfaction of having the “winning ticket” is sufficient. For this reason, the term “redeeming” is used in accordance with the principles of the present invention to include either turning the ticket into a vendor who may provide some form of reward, including financial reward, and/or other recognition. The redeeming of the ticket may also be provided by sending in the ticket and/or otherwise communicating with a given sponsor or source relative to the system and program of the present invention for the appropriate “reward”.

It should be emphasized that the terms “comprise”, “comprises”, and “comprising”, when used herein, are taken to specify the presence of stated features integers, steps, or components, but do not preclude the presence or addition of one or more other features, integers, steps, components or groups thereof.

The previous detailed Description is of embodiment(s) of the invention. The scope of the invention is instead defined by the following claims and the equivalents thereof.

What is claimed is:

1. A method for providing spectator interaction in a sporting event of a type including a plurality of participants, each of the plurality of participants having been assigned an indicia for identification and spectator interaction, the method comprising:
providing a hidden indicia on each one of a plurality of tickets, the hidden indicia associated with the indicia assigned to each of the plurality of participants of the sporting event;
distributing the plurality of tickets having the hidden indicia;
acquiring, by a spectator, at least one ticket from the plurality of tickets;
revealing, by the spectator, the hidden indicia to facilitate spectator interaction;
comparing the hidden indicia on the at least one ticket with the indicia assigned to a winning participant of the sporting event; and
redeeming the at least one ticket for reward if the hidden indicia on the at least one ticket matches the indicia assigned to the winning participant.

2. The method as set forth in claim 1, wherein the step of distributing the plurality of tickets includes the step of selling the plurality of tickets.

3. The method as set forth in claim 1, wherein the step of distributing the plurality of tickets includes the step of delivering the plurality of tickets to the spectators in association with a charitable event.

4. The method as set forth in claim 1, wherein the sporting event comprises an event from the group of baseball games, football games, basketball games, automobile races, track meets, marathons, equestrian competitions, rodeo competitions, and charitable competitions.

5. The method as set forth in claim 1, wherein the indicia comprises letters from an alphabet.

6. The method as set forth in claim 1, wherein the indicia includes a numeric value.

7. The method as set forth in claim 1, wherein the step of acquiring the at least one ticket tickets includes the step of purchasing the at least one ticket.

8. The method as set forth in claim 1, wherein the step of redeeming the at least one ticket for reward includes the step of redeeming the at least one ticket for acknowledgment.

9. The method as set forth in claim 1, wherein the step of redeeming the at least one ticket for reward includes the step of redeeming the at least one ticket for money.

10. The method as set forth in claim 1, wherein the step of redeeming the at least one ticket for reward includes the step of redeeming the at least one ticket for personal satisfaction.

11. The method as set forth in claim 1, wherein the step of redeeming the at least one ticket for reward includes the step of redeeming the at least one ticket for a gift.

12. The method as set forth in claim 1, wherein the hidden indicia is covered with a scratch-off layer.

13. The method as set forth in claim 1, wherein the hidden indicia is covered with a break-open window.

14. The method as set forth in claim 1, wherein the at least one ticket is acquired from a ticket vendor.

15. The method as set forth in claim 1, wherein the at least one ticket is acquired via an electronic booth.

16. The method as set forth in claim 1, wherein the at least one ticket is acquired via a global interconnection network.

17. A method for providing spectator interaction in a sporting event of a type including a plurality of participants, each of the plurality of participants having been assigned an indicia for identification and spectator interaction, the method comprising:
forwarding a numeric value to at least one spectator, the numeric value associated with the indicia assigned to each of the plurality of participants of the sporting event;
comparing the numeric value with the indicia assigned to a winning participant of the sporting event; and
redeeming a financial reward if the numeric value matches the indicia assigned to the winning participant.

18. The method as set forth in claim 17, wherein the step of forwarding is performed by a computer.

19. The method as set forth in claim 17, wherein the step of forwarding is performed by a telephone.

20. The method as set forth in claim 17, wherein the step of forwarding is performed via facsimile.

21. The method as set forth in claim 17, wherein the sporting event comprises an event from the group of baseball games, football games, basketball games, automobile races, track meets, marathons, equestrian competitions, rodeo competitions, and charitable competitions.

22. The method as set forth in claim 17, wherein the indicia includes a numeric value.
